(19) United States
(12) Patent Application Publication
(10) Pub. No.: US 2009/0074424 A1
(43) Pub. Date: Mar. 19, 2009

(54) DEVICE, SYSTEM AND METHOD OF TRANSFERRING INFORMATION OVER A COMMUNICATION NETWORK INCLUDING OPTICAL MEDIA

(76) Inventors: Hanna Inbar, Hod Hasharon (IL); Amir Burstein, Tel Aviv (IL); Zhahi Inbar, Yavne (IL); Zeev Orbach, Ashkelon (IL)

Correspondence Address: Pearl Cohen Zedek Latzer, LLP, 1500 Broadway, 12th Floor, New York, NY, 10036, US

(21) Appl. No.: 12/270,200

(22) Filed: Nov. 13, 2008

Related U.S. Application Data
(63) Continuation of application No. 11/311,937, filed on Dec. 20, 2005.
(60) Provisional application No. 60/636,856, filed on Dec. 20, 2004.

(51) Int. Cl. H04B 10/00

(52) U.S. Cl. 398/172

(57) ABSTRACT

Embodiments of the invention provide methods, devices and systems of transferring information upstream from two or more sets of user devices in a cable communication network. The system, according to some demonstrative embodiments of the invention, may include two or more optical transmitters to transmit two or more respective light beams having two or more respective wavelength spectra, the light beams carrying two or more respective optical signals of upstream information from the two or more sets of user devices, respectively; a combiner to combine the two or more light beams into a multicolor light beam carrying the two or more optical signals; and a multicolor receiver to convert the multicolor light beam into an electrical radio frequency signal carrying the information from the user devices. Other embodiments are described and claimed.

### CROSS-REFERENCE TO RELATED APPLICATIONS

This application claims priority of U.S. provisional Patent Application 60/636,856 filed Dec. 20, 2004, entitled “Systems, Devices, and Methods for Expanding Operational Bandwidth of Communication Infrastructure”, the disclosure of which is incorporated herein by reference in its entirety.

### FIELD OF INVENTION

The present invention generally relates to communication systems and methods and, more particularly, to devices, systems and methods of communicating information, e.g., over optical media.

### BACKGROUND OF THE INVENTION

Cable television (CATV) is a form of broadcasting that transmits programs to paying subscribers via a physical land based infrastructure of coaxial (“coax”) cables or via a combination of optical and coaxial cables (HFC).

CATV networks provide a direct link from a transmission center, such as a head-end, to a plurality of subscribers at various remote locations, such as homes and businesses, which are usually stationary and uniquely addressable. The head-end may be connected to the subscribers via local hubs, commonly referred to as “nodes”, which route the flow of data to and/or from a predefined group of subscribers, e.g., hundreds of subscribers, in a defined geographical area, for example, a small neighborhood or an apartment complex. The typical distances between the local nodes and the subscribers are relatively short, for example, up to a few thousand feet. Therefore, the communication between nodes and their subscribers is commonly referred to as “last mile” communication.

Existing CATV networks utilize a signal distribution service to communicate over multiple channels using various formats, for example, analog and/or digital formats for multi-channel TV programs, a high definition TV (HDTV) format, providing interactive services such as “video on demand”, and other multimedia services, such as Internet access, telephony and more.

A number of elements are involved in maintaining a desired flow of data through coaxial conductors or through a combination of fiber optics and coaxial cables from the head-end to the subscribers of a CATV system. In a conventional HFC cable TV system, the head end is connected to the local nodes via dedicated optical fibers. In the last mile system, each local node converts the optical signals received from the head-end into corresponding electrical signals, which may be modulated over a radio frequency (RF) carrier, to be routed to the local subscribers via coax cables.

The head-end is the central transmission center of the CATV system, providing content (e.g., programs) as well as controlling and distributing other information, e.g., billing information, related to customer subscribers.

The downstream signals, which are limited to designated channels within a standard frequency range (band) of 48 MHz to 860 MHz (or up to 1,000 MHz by recently introduced Stretching technology) are modulated on a light beam, e.g., at a standard wavelength of 1550 nm, and sent to the local node via a fiber-optical cable. An optical converter at the local node detects the optical signals and converts them into corresponding electrical signals to be routed to the subscribers.

In the reverse direction, the local optical node receives upstream data from all the local subscribers in the last mile section. These are carried by RF electrical signals at a standard frequency band of 5 MHz to 42 MHz, which does not overlap with the downstream band. A converter in the local optical node converts the upstream data into corresponding optical signals by modulating the data on an optical carrier beam, e.g., at a wavelength of 1310 nm, to be transmitted back to the head-end.

The electrical last mile system usually includes low-loss coax cables, which feed a plurality of serially-connected active elements, for example, line extension amplifiers and, if necessary, bridge trunk amplifiers (e.g., in case of splitting paths). In addition, many passive devices of various types may be fed by tapping from the main coaxial line in between the active amplifiers. These passive devices may be designed to equalize the energies fed to different subscriber allocations such that signals allocated to subscribers closer to the local node and/or to one or more of the active devices may be attenuated more than signals allocated to subscribers further away from the node or active devices.

In conventional systems, each passive device can feed a small group of subscribers, usually up to 8 subscribers, via drop cables having a predetermined resistance (e.g., 75Ω), feeding designated CATV outlets at the subscriber end. The drop cables are flexible and differ in attenuation parameters from the coaxial cables that feed the passive devices. The hierarchy of commonly used coaxial drop cables includes the RG-11 coaxial cable, which has the lowest loss and thus the highest performance, then the intermediate quality RG6-cable, and finally the basic quality cable. All drop cables used in the industry are usually connected using standard “F type” connectors.

### SUMMARY OF SOME DEMONSTRATIVE EMBODIMENTS OF THE INVENTION

Some demonstrative embodiments of the present invention provide a system for transferring information upstream from two or more sets of user devices in a cable communication network. The system may include two or more optical transmitters having two or more respective wavelength spectra to transmit two or more light beams carrying two or more optical signals of upstream information from the two or more sets of user devices, respectively.

The system may also include a combiner to combine the two or more light beams into a single multicolor light beam; and a multicolor receiver to convert the multicolor light beam into an electrical radio-frequency (RF) signal.

According to some demonstrative embodiments of the invention, the system may also include an optical modulator to convert the RF signal into an optical signal suitable for reception by a head-end of the cable communication network.

According to some demonstrative embodiments, the combiner may include a coarse wavelength division multiplexer or an optical coupler. In some embodiments, the multicolor receiver may be responsive to a grid of wavelength spectra of the two or more optical signals.

According to some demonstrative embodiments of the invention, a method for transferring information upstream from two or more sets of user devices of a cable communication network may include transmitting two or more light beams having two or more wavelength spectra and carrying two or more optical signals of upstream information from the two or more sets of user devices, respectively; combining the two or more light beams into a single multicolor light beam; and converting the multicolor light beam into an electrical RF signal carrying the uplink information from the two or more sets of user devices. Some embodiments may also include modulating the RF signal onto a light beam having a wavelength suitable for reception by a head-end of the cable communication network. In some embodiments, combining the two or more light beams may include multiplexing the two or more light beams according to a predetermined multiplexing scheme.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a hybrid optical-coaxial communication system according to some demonstrative embodiments of the present invention;

FIG. 2 is a schematic illustration of an upstream signal flow according to some demonstrative embodiments of the invention;

FIG. 3 is a schematic illustration of an optical converter according to some demonstrative embodiments of the invention;

FIG. 4 is a schematic illustration of an optical distributor according to some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF SOME DEMONSTRATIVE EMBODIMENTS OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

Various systems, methods and devices for expanding the effective bandwidth of conventional Cable Television (CATV) networks beyond the limited ranges of conventional downstream and upstream signals, e.g., by 200 percent or more, are described in U.S. ptent application Ser. No. 10/869,578, filed Jun. 16, 2004, entitled “A Wideband Node in a CATV Network” (Reference 1); European Patent Application 04253439, filed Jun. 10, 2004, entitled “A Wideband Node in a CATV Network”, and published Dec. 21, 2005 as EP Publication No. 1608168 (Reference 2); and/or in U.S. patent application Ser. No. 11/041,905, filed Jan. 25, 2005, entitled “DEVICE, SYSTEM AND METHOD FOR CONNECTING A SUBSCRIBER DEVICE TO A WIDEBAND DISTRIBUTION NETWORK”, and published Jul. 14, 2005 as U.S. publication No. 2005/0155082 (Reference 3), the entire disclosures of all of which applications are incorporated herein by reference. As described in these applications, the expansion of bandwidth may be achieved by introducing new active electronic devices, as well as new passive elements, along the last-mile coaxial portion of an existing HFC or other CATV network.

In some demonstrative embodiments of the invention described herein, the term “wide frequency band” may refer to an exemplary frequency band of, e.g., 5-3000 MHz; the term “extended upstream frequency band” may refer to an exemplary frequency band of 2250-2750 MHz; the term “extended downstream frequency band” may refer to an exemplary frequency band of 1250-1950 MHz; the term “legacy upstream frequency band” may refer to an exemplary frequency band of 5-42 MHz or 5-60 MHz; the term “legacy downstream frequency band” may refer to an exemplary frequency band of 54-860 MHz; and the term “legacy frequency band” may refer to an exemplary frequency band of 5-860 MHZ. However, it will be appreciated by those skilled in the art that in other embodiments of the invention, these exemplary frequency bands may be replaced with any other suitable wide frequency band, extended upstream frequency band, extended downstream frequency band, legacy downstream frequency band, legacy upstream frequency band, and/or any desired frequency band. For example, the systems, devices and/or methods of some embodiments of the invention may be adapted for a wide frequency band of between 5 MHz and more than 3000 MHz, e.g., 4000 MHz, and/or a legacy band of 5-1000 MHz.

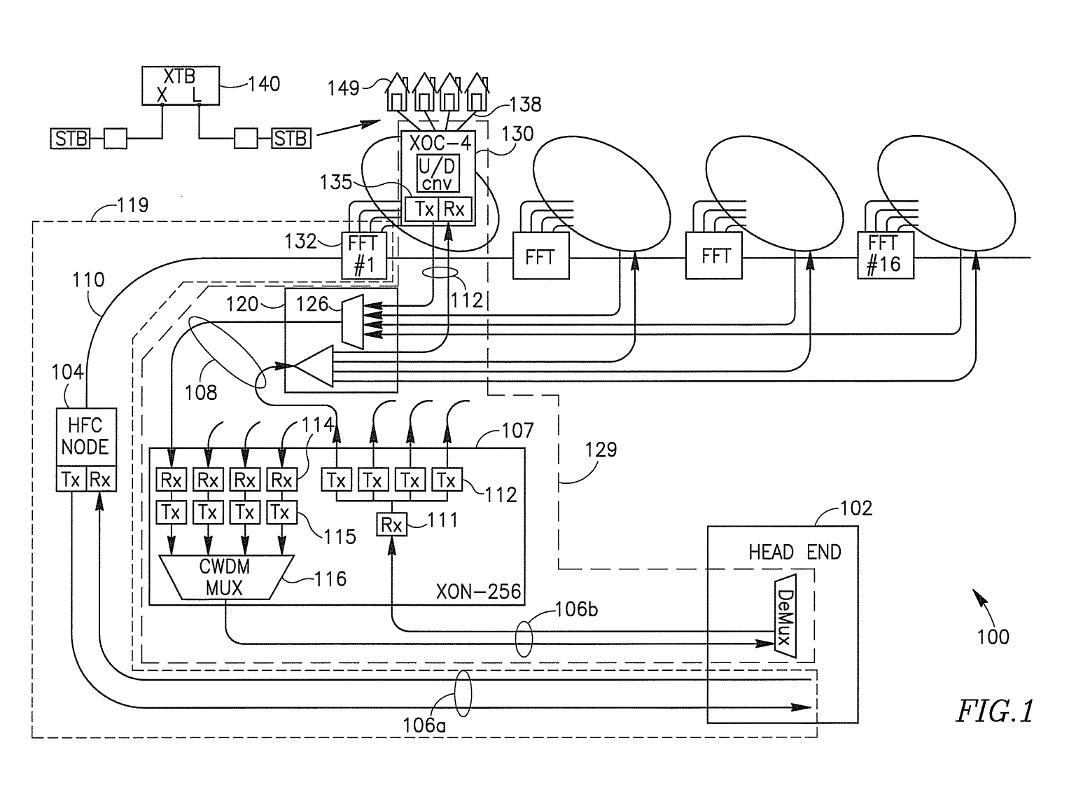

FIG. 1 schematically illustrates a hybrid optical-coaxial communication system according to some demonstrative embodiments of the present invention, showing the signal flow throughout the system.

According to some demonstrative embodiments of the invention, system 100 may include a first communication channel 119, and/or a second communication channel to communicate between a head end unit 102 and one or more subscribers 149, as described in detail below.

According to some demonstrative embodiments of the invention, communication channel 119 may include a node 104 able to communicate with head end 102 via one or more optical fibers 106a, e.g., as is known in the art. Downstream signals may be modulated on a carrier light beam having a wavelength of, for example, 1,550 nm or any other suitable wavelength, and upstream signals may be modulated on a carrier light beam having a wavelength of, for example, 1,310 nm or any other suitable wavelength.

Node 104 may include any suitable configuration, e.g., as is known in the art, for converting downstream optical signals received via fibers 106a into legacy downstream RF signals in a legacy downstream frequency band for transmission via a coaxial cable (coax) 110, and/or for converting legacy upstream RF signals in a legacy upstream frequency band received via coax 110 into optical signals suitable for transmission via fibers 106a.

According to some demonstrative embodiments of the invention, communication channel 119 may also include one or more Full Feature Taps (FFTs) 132 to distribute legacy downstream signals received from node 104 via coax 110 to one or more users (subscribers), and/or to provide node 104 via coax 110 with legacy upstream signals received from one or more subscribers, e.g., as is known in the art.

Although the invention is not limited in this respect, in the embodiment of FIG. 1, system 100 may include up to 256 subscribers, e.g., divided into up to sixty four sets of up to four subscribers. In this embodiment, channel 119 may include up to sixty four FFTs 132, each connectable to a respective set of, e.g., up to four, subscribers 149.

According to demonstrative embodiments of the invention, the downstream and/or upstream signals may include an expanded bandwidth enabled by one or more optical multiplexing technologies as are known in the art, e.g., Dense Wavelength Division Multiplexing (DWDM) or Coarse Wavelength Division Multiplexing (CWDM).

Although the invention is not limited in this respect, according to some demonstrative embodiments of the invention, communication channel 129 may enable communicating expanded downstream and/or upstream signals between head-end 102 and one or more of subscribers 149. The extended upstream and/or downstream signals may be generated, for example, by block division multiplexing, e.g., as described in References 1, 2, and/or 3.

According to demonstrative embodiments of the invention, communication channel 129 may include one or more extended optical converters (XOCs) 130 to selectively transfer expanded upstream and/or expanded downstream data to/from one or more subscribers via at least one local fiber 108, as described in more detail below. In some demonstrative embodiments of the present invention, legacy services may still be provided to the subscriber. For example, the connection from FFT 132 to a subscriber wall outlet may be via XOC 130, which may be adjacent, for example, to FFT 132. XOC 130 may be connected to the subscriber wall outlet via a coaxial drop cable 138. XOC 130 may selectively transfer upstream and/or downstream data to/from one or more subscribers via FFT 132 and coax 110. XOC 130 may be connected to a plurality of subscribers, e.g., up to four subscriber locations, via at least one Wideband Subscriber Interface Unit (XTB) 140 per location. XTB 140 may separate the legacy services (designated by L) from the extended services (designated by X). In some embodiments of the present invention, one or more of XTBs 140 may be located near user devices at subscriber locations that require an expanded bandwidth. In these embodiments, there may be more than four XTBs 140 per XOC 130. In some embodiments of the present invention, these extended services may include additional downstream and/or upstream bandwidth. Although the invention is not limited in this respect, in the embodiment of FIG. 1, channel 129 may include up to sixty four XOCs 130, each connectable to a respective set of, e.g., up to four, subscribers 149, e.g., via a respective offset of up to four XTBs 140, and to a respective FFT 132. In the embodiment of FIG. 1, the sixty four XOCs 130 may be divided, for example, into four sets of sixteen XOCs 130.

According to some demonstrative embodiments of the invention, XTB 140 may include any suitable XTB configuration, e.g., as described in References 1, 2, and/or 3. For example, XTB 140 may communicate standard CATV data with the subscribers, e.g., 48 MHz to 1000 MHz downstream and 5 MHz to 42 MHz (or 85 MHz) upstream, and provide the expanded data in higher downstream and/or upstream frequency ranges, which may be converted to respective suitable ranges within the legacy upstream and/or downstream bands. For example, a 1250 MHz to 1950 MHz expanded downstream band may be converted into a 160 to 860 MHz new downstream legacy band, and a 2250 to 2750 MHz expanded upstream band may be converted to multiples of 5-42 MHz (or 10 to 85 MHz), e.g. 1100-1150 MHz, within the upstream band. It will be appreciated that this aspect of the invention is not limited to any specific expanded frequency ranges, and that any other desired ranges may also be suitable for use in conjunction with embodiments of the invention; for example, some embodiments of the invention may use a 1100-1900 MHz expanded downstream range and/or a 2100-2900 MHz expanded upstream range.

According to some demonstrative embodiments of the invention, channel 129 may also include one or more extended optical distributors (XODs) 120. Although the invention is not limited in this respect, in the embodiment of FIG. 1, channel 129 may include four XODs 120, each connectable, for example, to one of the four sets of sixteen XOCs, respectively, e.g., by sixteen distinct fibers 112. In some embodiments, e.g. the embodiment of FIG. 1, each fiber of fibers 112 may include two uni-directional fibers, although a single bi-directional fiber may be used without departing from the scope of the present invention. If a single bi-directional fiber is used for both upstream and downstream, XOC 30 may also include an optical selector (not shown) to reflect, deflect, transmit, or route a light beam according to the wavelength of the light beam. The optical selector may include, for example, a dichroic mirror with built-in wavelength filters, e.g., as is known in the art.

According to some demonstrative embodiments of the invention, XOC 130 may include an optical transmitter 135 to transmit signals from one or more XTBs 140 to XOD 120. One or more of the XOCs of channel 129 may transmit an optical signal having a different wavelength spectrum. For example, the sixteen XOCs of each of the XOC sets of FIG. 1 may transmit optical signals of sixteen different wavelength spectra. Accordingly, XOD 120 may receive upstream optical signals from XOC 130s, each at a different wavelength or color to distinguish the upstream signals. It is to be appreciated by those of ordinary skill in the art that different numbers of XOCs per XODs may be connected within the scope of the present invention.

According to some demonstrative embodiments of the invention, XOD 120 may include a combiner 126 to combine upstream signals received from XOCs 130 into a multi-color upstream signal. Combiner 126 may include, for example, a multiplexer or an optical coupler, e.g., as are known in the art. The multi-color upstream signal may be transmitted upstream via fibers 108.

According to some demonstrative embodiments of the invention, channel 129 may also include an Extended Services Optical Node (XON) 107 in connection with fiber 108 to receive one or more multicolor upstream signals. Although the invention is not limited in this respect, in the embodiments of FIG. 1, XON 107 may receive up to four multi-color signals, e.g., from the four XODs, respectively. XON 107 may operate in conjunction with node 104 or independently.

According to some demonstrative embodiments of the invention, XON 107 may be able to regenerate the upstream optical signal received via fibers 108, as describe below. XON 107 may include, for example, one or more multi-signal optical receivers 114 to receive data via a respective one or more multi-color signals from the one or more XODs 120, respectively. Receiver 114 may receive the multicolor upstream signal which may include, for example, data optically encoded across multiple wavelength spectra. Receiver 114 may also convert the optical data into a multichannel RF upstream signal. Receiver 114 may include any suitable receiver, e.g., an optical to RF converter as is known in the art that may meet the requirements of the present invention for receiving the multicolor signal. XON 107 may also include one or more optical transmitters 115, e.g., four transmitters, to receive one or more RF upstream signals from one or more receivers 114, respectively. Transmitter 115 may retransmit the RF upstream signal optically. Transmitter 115 may include any suitable transmitter, e.g., including an RF to optical converter as is known in the art. Receiver 114, transmitter 115 and/or XON 107 may optionally include an amplifier to amplify the RF signal.

For the embodiment of FIG. 1, XON 107 may include up to four receivers 114. With up to sixteen wavelengths on each fiber 108 representing up to 64 subscribers, each XON 107 may receive data from up to 256 subscribers. It is to be appreciated by one skilled in the art that, although FIG. 1 shows 16 wavelength spectra received by each optical receiver 114, different numbers of wavelength spectra may be received on each fiber 108 without departing from the spirit of the present invention.

According to some demonstrative embodiments of the invention, XON 107 may also include a combiner to combine the optical outputs of one or more transmitters 115 into an upstream optical signal to be transmitted over one or more fibers 106b, e.g., to head end 102. For example, XON 107 may include a multiplexer 116, e.g., a CWDM multiplexer as is known in the art, such that the wavelengths of multiplexer 116 are consistent, for example, with outputs of transmitters 115. In other embodiments, XON may include any other suitable combiner, e.g., an optical coupler.

According to some demonstrative embodiments of the invention, head end 102 may connect to XODs 120, e.g., directly. This may eliminate, for example, the need for XON 107. For these embodiments (not shown), head-end 102 may receive the multicolor upstream signals, e.g., directly via fiber 108; and transmits the downstream signals XOD 120 for distribution to the subscribers.

According to some demonstrative embodiments of the invention, in the downstream direction, XON 107 may include a receiver 111 to receive downstream optical signals via fibers 106b. XON 107 may be able to regenerate the downstream optical signal received via fibers 106b. Receiver 111 may include any suitable receiver, e.g., including an optical to RF receiver, able to convert the downstream optical signal into an RF signal. Although the invention is not limited in this aspect, receiver 111 may optionally include an amplifier to amplify the RF signal, and/or a splitter to split the RF signal, e.g., into four RF signals. XON 107 may also include one or more transmitters 112, e.g., four transmitters, to modulate the data of the one or more RF signals over one or more respective optical signals to be transmitted over optical fibers 108. For example, transmitter 112 may include an RF-to-optical converter, e.g., as is known in the art. In some embodiments, optical amplification may be used to amplify the signals in XON 107 instead of optical regeneration. In some embodiments, a passive optical splitter may be used, e.g., at the output of the optical amplifier, to split the amplified optical signal into two or more, e.g., four, separate optical signals. The embodiment of FIG. 1 shows the downstream signal split into four paths, although other split ratios may be used.

According to some demonstrative embodiments of the invention, two or more, e.g., four different wavelengths may be transmitted to XON 107 via fibers 106b. For some of these embodiments (not shown), XON 107 may include a WDM demultiplexer to demultiplex the signals into four streams to be converted by four receivers 111, respectively, into four respective RF signals. Four transmitters 112 may then transmit the data over optical fibers 108. For other embodiments (not shown), XON 107 may include an optical amplifier to amplify the optical signals carried by the four wavelengths, and a WDM demultiplexer to split the four signals for transmission over four separate optical fibers 108.

According to some demonstrative embodiments of the invention, head-end 102 may include any suitable hardware and/or software, e.g., including any suitable optical transmitters and/or receivers, configured to transmit and/or receive data to/from subscribers 149. For example, head-end 102 may include a demultiplexer and a cable modem termination system (CMTS) as are well known in the art (not shown in FIG. 1). For the embodiment of FIG. 1, the CMTS may be configured for one set of 256 downstream subscribers and four service groups of 64 upstream subscribers, although CMTS configurations for other numbers of subscribers and/or service groups may also be used without departing from the scope of the invention.

According to some demonstrative embodiments of the invention, head-end 102 may communicate with subscribers 149 according to any suitable communication protocol or standard, e.g., the Data Over Cable Service Interface Specifications (DOCSIS) standard. It is an advantage of the present invention that the combination of a CMTS and DOCSIS provide sufficient frequency and timing allocation through frequency division multiplexing and time division multiplexing such that implementation of the embodiments of the invention described herein may require no modification to existing cable modem or CMTS systems. In particular, a CMTS designed to accommodate 256 subscribers in a downstream-upstream ratio of 1:4 with 1 downstream port for up to 256 subscribers and 4 upstream ports, e.g., each upstream port communicating with one service group of up to 64 subscribers, respectively, may be adopted for the embodiment of FIG. 1 without modification. A CMTS card for this demonstrative embodiment may be configured to include, for example, one downstream port and four upstream ports, thereby to match the downstream subscriber capability.

Furthermore, for the embodiment of FIG. 1, head-end 102 may include down conversion for upstream and up conversion for downstream, to fit the extended services frequency plan. For embodiments where XOC 130 includes RF up-conversion and/or RF down-conversion, such that the optical signal transmitted by transmitter 135 carries RF Legacy frequencies rather than expanded RF frequencies, no further conversion may be required for downstream at head-end 102. For upstream, further down-conversion may be required, e.g., if upstream signals are stacked up—first at 5 to 42 MHz, second above it and so forth.

Some demonstrative embodiments of the invention are described herein in relation to a communication system, e.g., system 100, including a first communication channel, e.g., channel 119, for transmitting legacy upstream and/or downstream signals, and/or a second communication channel, e.g., channel 129, for transmitting extended upstream and/or downstream signals. However, it will be appreciated by those of ordinary skill in the art, that other embodiments may include a communication system including only one communication channel, e.g., channel 129, to distribute legacy and/or extended signals. For example, the communication system may include communication channel 129 to transfer upstream legacy and/or extended signals from subscribers 149 to head end 102; and/or downstream legacy and/or extended signals from head end 102 to subscribers 149.

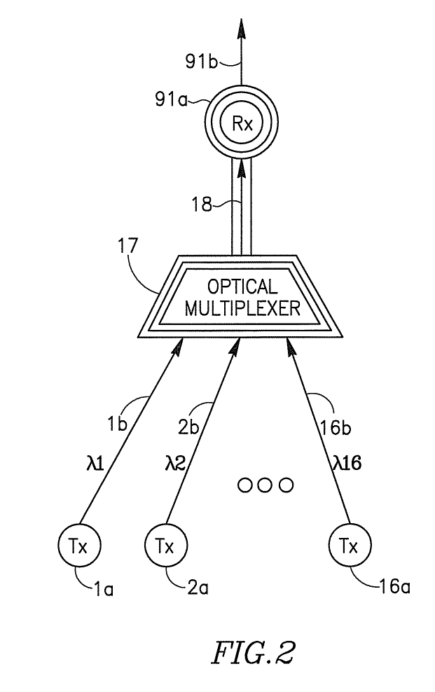

FIG. 2 schematically illustrates the upstream signal flow through a communication channel, e.g., channel 129, according to some demonstrative embodiments of the present invention.

According to some demonstrative embodiments of the invention, an optical transmitter 1a may transmit an optical signal having a first wavelength spectrum, denoted λ1, over a first optical fiber 1b, an optical transmitter 2a may transmit an optical signal having a second wavelength spectrum, denoted λ2, over a second optical fiber 2b, and so forth up to an optical transmitter 16a transmitting an optical signal having a sixteenth wavelength spectrum, denoted λ16, over a sixteenth optical fiber 16b. Fibers 1b up to 16b may be connected to an optical combiner 17, which may optically combine the optical signals of the sixteen different wavelength spectra into a multicolor optical signal to be transmitted to a multi-color receiver 91a over an optical fiber 18. Although the demonstrative embodiment of FIG. 2 depicts a data flow of 16 optical signals, it will be appreciated by those of ordinary skill in the art that the invention is not limited in this respect, and that other embodiments of the invention may include transmitting any other suitable number, N, of optical signals, wherein the dynamic range of receiver 91a may influence the upper limit of N. The values of one or more of the wavelengths λ1 up to λN, where in this exemplary embodiment X=16, may be sufficiently separated from one another, for example, by 100 GHz, e.g., in order to avoid interference between the different optical wavelengths, and to achieve incoherent detection by the optical detector. It should be noted that the embodiment of FIG. 1 shows, as discussed above, four multicolor signal receivers 114 (FIG. 1).

According to some demonstrative embodiments of the invention, the transmitters 1a, 2a, etc. may modulate the corresponding optical signals in a suitable modulation formats such as, but not restricted to, analog AM or digital QAM. In some demonstrative embodiments of the invention each one of the optical signals may be modulated onto a number of RF carriers, e.g., such that the RF spectrum of the channels may be expected to be differentiated from each other. In one example, optical combiner 17 may be a wavelength division multiplexer, or a passive optical coupler, e.g., having a wavelength-insensitive insertion loss, which may be at least within the relevant range of wavelengths.

According to some demonstrative embodiments of the invention, receiver 91a may have an operating wavelength spectrum including the wavelength spectra of the 1 to N optical signals, e.g., λ1 to λ16. Receiver 91a may convert the received optical signals into an RF signal 91b, which may include, for example, information corresponding to the information of one or more, e.g., substantially all, of signals 1b . . . 16b. The information carried by signal 91b may be processed, e.g., at head end 102 (FIG. 1), to provide sixteen separate information streams of the transmitters, for example, since each one of signals 1b . . . 16b may be transmitted on a distinct RF carrier. In some embodiments using both frequency division and time division multiplexing, the RF carriers may be the same for all wavelengths, provided that not more than one wavelength uses the same RF frequency at any one time to assure the integrity of the data.

According to some demonstrative embodiments of the invention, a wavelength grid implemented by optical receiver 91a and/or transmitters 1a . . . 16a may be chosen such that the wavelengths of signals 1b . . . 16b may be sufficiently separated, e.g., so as to eliminate any interference between them. In some embodiments of the present invention, the wavelength separation may be chosen such that the difference in optical frequencies is much greater than can be detected by optical receiver 91a. In some embodiments, a CWDM grid, for example, a grid of at least 0.4 nm, e.g., at least 1 nm. For example, a grid of at least 10 nm, e.g., 20 nm grid, may be used for the wavelength grid. The implementation of a CWDM grid is typically less expensive than a DWDM grid in that the CWDM grid may lower other CATV system costs by allowing the use of un-cooled lasers and simpler passive optical filters which have relatively modest operating environment requirements.

According to some demonstrative embodiments of the invention, a total optical power (“overload power”) allowed in optical receiver 91a, i.e. as received from transmitters 1a through 16a, may be limited by its design and materials, e.g., in order to enable proper operation of optical receiver 91a. For optical receivers that are commercially available today, a representative overload power may be between 1 and 2 dBm (where dBm=10*log(optical power in mW). For a representative embodiment having an optical receiver with a 2 dBm limit and 16 inputs, each input may not exceed, for example, 2 dBm−10*log(16)=2 dBm−12 dB=−10 dBm. However, practical system non-uniformities and uncertainties, e.g. in optical filters, couplers and connectors as well as laser level tracking errors, and/or drift over the life span of the system, may also be considered in determining the input signal power level, thereby lowering the maximum allowable power level per wavelength, e.g., to a value lower than −10 dBm.

Additionally, optical receiver performance may be affected by the uniformity of the input signal power levels. Adjusting the optical modulation index of the input signals may be used to improve performance in some embodiments.

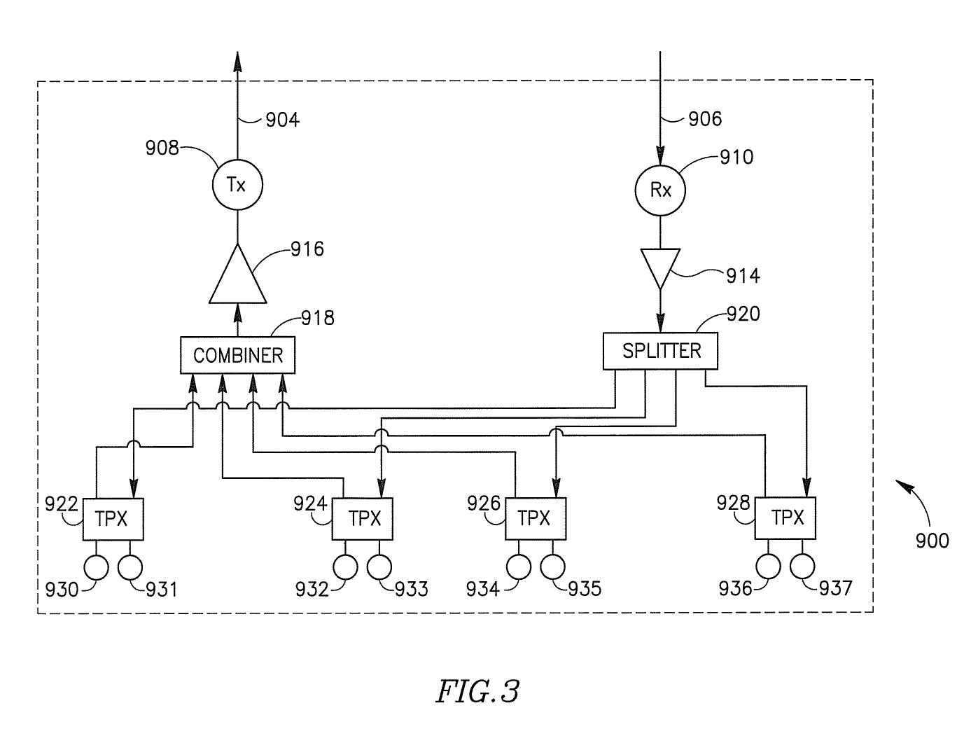

Reference is made to FIG. 3, which schematically illustrates an XOC configuration 900 according to some demonstrative embodiments of the invention. Although the invention is not limited in this respect, XOC 900 may perform the functionality of XOC 130 (FIG. 1).

According to some demonstrative embodiments of the invention, XOC 900 may be connected to optical fiber 112 (FIG. 1), e.g., by an upstream fiber 904 and a downstream fiber 906. XOC 900 may receive, for example, an optical downstream signal via fiber 906; and/or transmit an optical upstream signal via fiber 904.

According to some demonstrative embodiments of the invention, XOC 900 may include at least one triplexer, e.g., triplexers 922, 924, 926, and 928. XOC 900 may also include a downstream amplifier 914, an optical-to-RF converter 910, an upstream amplifier 916, a combiner 918, a splitter 920, and/or a RF-to-optical converter 908, as are described below.

According to some demonstrative embodiments of the invention, triplexer 922 may be connected, e.g., on one side, to a subscriber connector 930 and to a tap connector 931; and to combiner 918, and splitter 920, e.g., on another side. Triplexer 922 may be able to provide subscriber connector 930 with expanded downstream signals received via splitter 920; to provide subscriber connector 930 with downstream signals received from tap connector 931; to provide combiner 918 with expanded upstream signals received from subscriber connector 930; and/or to provide tap connector 931 with upstream signals received from subscriber connector 930. Triplexer 924 may be connected, e.g., on one side, to a subscriber connector 932 and to a tap connector 933; and to combiner 918, and splitter 920, e.g., on another side. Triplexer 924 may be able to provide subscriber connector 932 with expanded downstream signals received via splitter 920; to provide subscriber connector 932 with downstream signals received from tap connector 933; to provide combiner 918 with expanded upstream signals received from subscriber connector 932; and/or to provide tap connector 933 with upstream signals received from subscriber connector 932. Triplexer 926 may be connected, e.g., on one side, to a subscriber connector 934 and to a tap connector 935; and to combiner 918, and splitter 920, e.g., on another side. Triplexer 926 may be able to provide subscriber connector 934 with expanded downstream signals received via splitter 920; to provide subscriber connector 934 with downstream signals received from tap connector 935; to provide combiner 918 with expanded upstream signals received from subscriber connector 934; and/or to provide tap connector 935 with upstream signals received from subscriber connector 934. Triplexer 928 may be connected, e.g., on one side, to a subscriber connector 936 and to a tap connector 937; and to combiner 918, and splitter 920, e.g., on another side. Triplexer 928 may be able to provide subscriber connector 936 with expanded downstream signals received via splitter 920; to provide subscriber connector 936 with downstream signals received from tap connector 937; to provide combiner 918 with expanded upstream signals received from subscriber connector 936; and/or to provide tap connector 937 with upstream signals received from subscriber connector 936.

According to some demonstrative embodiments, triplexers 922, 924, 926, and/or 928 may enable only legacy CATV signals to pass, e.g., if no subscriber is connected to connectors 930, 932, 934, and/or 936, respectively.

According to some demonstrative embodiments of the invention, triplexers 922, 924, 926 and/or 928 may be constructed, for example, with SM1 lamped elements and/or using any other suitable technologies, e.g., including CMOS integration.

Amplifier 914 may include, for example, a 1250-1950 MHz 18 dB amplifier. Amplifier 916 may include, for example, a 2250-2750 MHz 16 dB amplifier. Amplifiers 914 and/or 916 may include any other suitable amplifier, e.g., corresponding to the extended or legacy upstream and/or downstream frequency bands.

According to some demonstrative embodiments of the invention, optical-to-RF converter 910 may include any suitable converter, e.g., a PIN diode as is known in the art. RF-to-optical converter 908 may also include any suitable converter, e.g., a converter using a laser source, e.g., a diode laser.

According to some demonstrative embodiments of the invention, combiner 918 may include any suitable RF combiner to provide one or more upstream signals received from triplexers 922, 924, 926, and 928 to amplifier 916. Splitter 920 may include any suitable RF splitter to the downstream RF signal received from amplifier 914 into two or more RF signals, e.g., four RF signals, to be provided to two or more triplexers, e.g., triplexers 922, 924, 926, and 928, respectively.

It will be appreciated that the configuration of FIG. 3 may allow substantially no transfer of signals (“signal theft”) between one or more subscribers connected to one or more of connectors 930, 932, 934 and 936, since each subscriber is connected via a different triplexer.

Although the XOC 900 of this embodiment may be shared by up to four subscribers, it is to be appreciated that other sharing arrangements are also plausible, including, but not limited to, one, two, or eight subscribers per XOC 900.

In other embodiments of this invention the optical transport may include the CATV legacy services, thus eliminating any RF connection to the coaxial infrastructure of the HFC plant. In these embodiments, XOC 900 may have a different internal structure than that shown in FIG. 3, e.g., a structure that passes legacy services through to an XTB along with the extended services. In yet other embodiments, the RF frequency spectrum may be different. Moreover, XOC 900 may include down-conversion and/or up-conversion, such that the optical signal may carry RF legacy frequencies, e.g. below 1 GHz, rather than elevated RF frequencies.

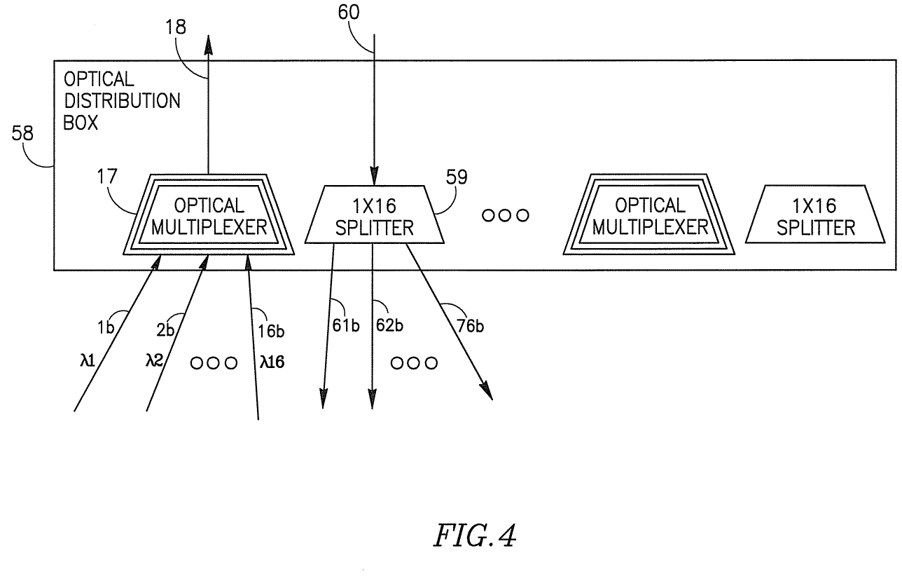

FIG. 4 schematically illustrates an XOD 58, which may connect XOC boxes to an optical node according to some demonstrative embodiments of the invention. Although the invention is not limited in this respect, XOD 58 may perform the functionality of XOD 120 (FIG. 1).

According to some demonstrative embodiments of the invention, an upstream portion of XOD 58 may include an optical multiplexer 17. Multiplexer 17 may receive, for example, sixteen upstream optical signals, denoted 1b through 16b, e.g., from sixteen XOCs. In a downstream portion XOD 58 may include an optical splitter 59 to split, e.g., passively split, a downstream optical signal 60 e.g., received from an optical node. For some embodiments, optical splitter 59 may divide the downstream signal into downstream signals to be transferred over sixteen fibers, 61b to 76b, which may be connected to sixteen respective XOCs 130 (FIG. 1). It will be appreciated that a split ratio of 16 is illustrative; other split ratios, e.g. 4 or 8, are also possible without departing from the spirit of the present invention. Although the XOD in the embodiment of FIG. 1 has only one pair of optical multiplexer 17/optical splitter 59 corresponding to 64 subscribers, FIG. 4 shows that optical distribution box 58 may include four pairs of optical multiplexer 17/optical splitter 59, corresponding to up to 256 subscribers. However other embodiments of this invention may include a different number of passive optical multiplexers and splitters.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A system of transferring information upstream from two or more sets of user devices in a cable communication network, the system comprising:
two or more optical transmitters to transmit two or more respective light beams having two or more respective wavelength spectra, the light beams carrying two or more respective optical signals of upstream information from the two or more respective sets of user devices;
a combiner to combine the two or more light beams into a multicolor light beam carrying said two or more optical signals; and
a multicolor receiver to convert said multicolor light beam into an electrical radio frequency signal carrying said upstream information.

2. The system of claim 1 comprising an optical modulator to modulate the electrical radio-frequency signal onto an upstream light beam suitable for communication on said cable communication network.

3. The system of claim 2 comprising a head-end of said cable communication network to receive the upstream light beam.

4. The system of claim 1, wherein the combiner comprises a wavelength division multiplexer to multiplex the two or more light beams into said multicolor light beam according to a predetermined multiplexing scheme.

5. The system of claim 1, wherein the combiner comprises an optical coupler to couple the two or more light beams into a multicolor light beam carrying said two or more optical signals.

6. The system of claim 5, wherein said coupler has a wavelength-insensitive insertion loss within the wavelength range of the two or more light beams.

7. The system of claim 1, wherein said multicolor receiver is able to modulate the upstream information of said two or more optical signals onto said electrical radio frequency signal.

8. The system of claim 1, wherein the multicolor receiver is responsive to a wavelength range including a wavelength grid of said two or more wavelength spectra.

9. The system of claim 8, wherein the wavelength grid comprises a coarse wave division multiplexing grid corresponding to said two or more wavelength spectra.

10. The system of claim 9, wherein the coarse wave division multiplexing grid has a wavelength separation of at least 0.4 nanometer.

11. The system of claim 10, wherein the coarse wave division multiplexing grid has a wavelength separation of at least 1 nanometer.

12. The system of claim 11, wherein the coarse wave division multiplexing grid has a wavelength separation of at least 10 nanometer.

13. The system of claim 1, wherein said two or more sets of user devices are adapted to modulate said upstream information according to a Time Division Multiple Access modulation scheme.

14. The system of claim 1, wherein said two or more sets of user devices operate under the Data Over Cable Service Interface Specifications.

15. A method of transferring information upstream from two or more sets of user devices in a cable communication network, the method comprising:
transmitting two or more light beams having two or more respective wavelength spectra, the light beams carrying two or more respective optical signals of upstream information from two or more respective sets of user devices;
combining the two or more light beams into a multicolor light beam carrying said two or more optical signals; and
converting said multicolor light beam into an electrical radio frequency signal.

16. The method of claim 15 comprising modulating the electrical radio-frequency signal onto an upstream light beam.

17. The method of claim 16 comprising receiving the upstream light beam.

18. The method of claim 15, wherein combining said two or more light beams comprises multiplexing the two or more light beams into said multicolor light beam according to a predetermined multiplexing scheme.

19. The method of claim 15, wherein combining said two or more light beams comprises coupling the two or more light beams into a multicolor light beam carrying said two or more optical signals.

20. The method of claim 19, wherein coupling the two or more light beams comprises coupling the two or more light beams with a wavelength-insensitive insertion loss within the wavelength range of the two or more light beams.

21. The method of claim 15, wherein converting said multicolor light beam comprises modulating the upstream information of said two or more optical signals onto said radio frequency signal.

22. The method of claim 15, wherein converting said multicolor light beam is responsive for a wavelength range including the wavelength grid of said two or more wavelength spectra.

23. The method of claim 22, wherein the wavelength grid comprises a coarse wave division multiplexing grid corresponding to said two or more wavelength spectra.

24. The method of claim 23, wherein the coarse wave division multiplexing grid has a wavelength separation of at least 0.4 nanometer.

25. The method of claim 15 comprising modulating said upstream information according to a Time Division Multiple Access modulation scheme.

26. The method of claim 15 comprising modulating said upstream information according to the Data Over Cable Service Interface Specifications.
